(19) United States
(12) Patent Application Publication
(10) Pub. No.: US 2025/0181641 A1
(43) Pub. Date: Jun. 5, 2025

(54) RETRIEVAL AUGMENTED GENERATION FOR VIDEOS

(71) Applicant: NEC Laboratories America, Inc., Princeton, NJ (US)

(72) Inventors: Biplob Debnath, Princeton, NJ (US); Srimat Chakradhar, Manalapan, NJ (US); Murugan Sankaradas, Dayton, NJ (US); Md Adnan Arefeen, Kansas City, MO (US); Ravi Kailasam Rajendran, Colonia, NJ (US)

(21) Appl. No.: 18/968,204

(22) Filed: Dec. 4, 2024

Related U.S. Application Data
(60) Provisional application No. 63/606,224, filed on Dec. 5, 2023.
(60) Provisional application No. 63/610,084, filed on Dec. 14, 2023.
(60) Provisional application No. 63/622,778, filed on Jan. 19, 2024.
(60) Provisional application No. 63/565,698, filed on Mar. 15, 2024.

(51) Int. Cl. G06F 16/78

(52) U.S. Cl. CPC G06F 16/7867

(57) ABSTRACT

Methods and systems for video analysis include pre-processing clips of an input video using a first vision model to generate respective first textual descriptions for the clips. A subset of the clips that are relevant to a query is selected based on the first textual descriptions. Additional textual descriptions are generated for the selected subset using a second vision model. The query is answered using the additional textual descriptions.

### RELATED APPLICATION INFORMATION

This application claims priority to U.S. Patent Application No. 63/606,224, filed on Dec. 5, 2023, to U.S. Patent Application No. 63/610,084, filed on Dec. 14, 2023, to U.S. Patent Application No. 63/622,778, filed on Jan. 19, 2024, and to U.S. Patent Application No. 63/565,698, filed on Mar. 15, 2024, each incorporated herein by reference in its entirety.

### BACKGROUND

### Technical Field

The present invention relates to machine learning models and, more particularly, to retrieval augmented generation.

### Description of the Related Art

Applications for intelligent video understanding include human-robot interaction, improvements to safety and efficiency of autonomous driving systems, and intelligent surveillance for security and situational awareness. Analyzing and interpreting video data in real-time or by post-processing helps to make informed decisions and to take appropriate responsive actions.

Machine learning models for video understanding may include models that are pre-trained general purpose models that are fine-tuned for a specific task, such as action recognition, summarization, or captioning. This fine-tuning impedes the adaptability of the models to meet the diverse needs of different real-world use cases, restricting their ability to handle new tasks or environments without significant reconfiguration. This inflexibility reduces the models' versatility.

### SUMMARY

A method for video analysis includes video analysis include pre-processing clips of an input video using a first vision model to generate respective first textual descriptions for the clips. A subset of the clips that are relevant to a query is selected based on the first textual descriptions. Additional textual descriptions are generated for the selected subset using a second vision model. The query is answered using the additional textual descriptions.

A system for video analysis includes a hardware processor and a memory that stores a computer program. When executed by the hardware processor, the computer program causes the hardware processor to pre-process clips of an input video using a first vision model to generate respective first textual descriptions for the clips. A subset of the clips that are relevant to a query is selected based on the first textual descriptions. Additional textual descriptions are generated for the selected subset using a second vision model. The query is answered using the additional textual descriptions.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating video analysis and question answering using a large language model (LLM), in accordance with an embodiment of the present invention;

FIG. 2 is a block/flow diagram of a method for incremental elaboration of video analysis, in accordance with an embodiment of the present invention;

FIG. 3 is a block/flow diagram of a method for integrating incremental video analysis in a video processing task, in accordance with an embodiment of the present invention;

FIG. 4 is a block diagram of a computing device that can perform incremental video analysis, in accordance with an embodiment of the present invention;

FIG. 5 is a diagram of an exemplary neural network architecture that can be used to implement part of a vision model, in accordance with an embodiment of the present invention;

FIG. 6 is a diagram of an exemplary deep neural network architecture that can be used to implement part of a vision model, in accordance with an embodiment of the present invention;

FIG. 7 is a block/flow diagram of a method for performing batch processing of video clips with incremental video analysis, in accordance with an embodiment of the present invention; and

FIG. 8 is a block/flow diagram of a method for selecting and updating an initial vision model in accordance with a video domain, in accordance with an embodiment of the present invention.

### DETAILED DESCRIPTION OF PREFERRED EMBODIMENTS

Video understanding may be reframed in the context of a natural language processing task in a question-and-answer framework. This approach makes use of a large language model (LLM) to convert visual information from videos into text, which text may then be used to answer questions about the video.

An input video may be divided into clips, and one or more vision models may be used to extract metadata. Some models may be better suited for a particular task than others. To process a user query related to the video, an LLM processes the query and the metadata to generate an answer. If the LLM does not have sufficient information to generate the answer, additional models may be used on the relevant clip(s) to acquire supplementary metadata. The LLM can be used to make a determination about which model(s) should be used to extract the missing metadata.

Rather using a fixed set of models to extract all textual information from the video up-front, a subset of the models may be used initially and may be supplemented incrementally responsive to the specific user queries. This saves on computational expense, as unneeded video processing is avoided, without sacrificing accuracy. Information may then be extracted from the video according to a user's immediate needs.

To make this efficiency possible, it is determined whether the LLM can derive an answer from the previously extracted information. Information generated by multiple models can be consolidated with the user's query and any prompts, and this updated collection can be used by the LLM to generate an answer. This iterative process helps to dynamically adapt to queries, progressively enhancing the systems' ability to answer questions for a given video.

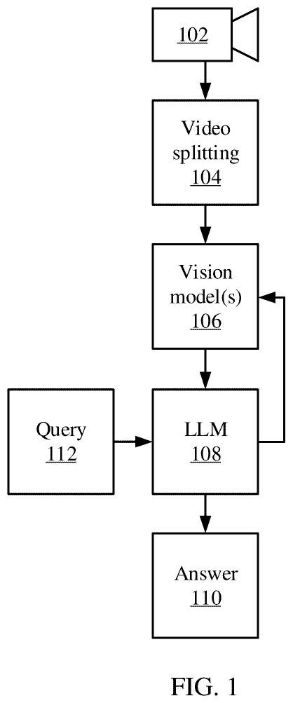

Referring now to FIG. 1, a video understanding system is shown. A camera 102 generates a series of video frames captured from a scene. Video splitting 104 divides the camera's video output into a set of video clips, for example having a predetermined length or being divided according to scene changes. One or more vision models 106 processes the video clips to extract textual descriptions, for example identifying objects and actions that are shown in the video clips. This textual information may be stored as metadata relating to respective clips. An initial subset of the available vision models 106 is used at first, for example representing a predetermined number of general-purpose or common video analysis tasks.

An LLM 108 processes a query about the video using the metadata that is generated by the vision models 106. This may include a determination of whether the query 112 can be answered using the metadata that is currently available. If not, then the LLM 108 selects one or more additional vision models 106, which process the video clips to generate additional metadata. This process may be repeated as needed until the LLM can generate an answer 110 to the query 112 based on the information extracted from the video.

The vision models 106 may be lightweight models with relatively few parameters. While such lightweight models reduce the computational burden of analysis and reduce indexing time, the resulting text descriptions may not be as rich. Thus the LLM 108 may fail to answer a query due to a lack of information in the metadata. The additional vision models 106 may be selected to provide more detailed information using models with more parameters, using models that are tuned for a different environment or context, or models that are tuned for a previously unanalyzed task. The newly selected vision model(s) 106 need not be run on all of the video clips, but may instead be run on a subset of the video clips that are relevant to the query 112.

Pre-processing the video clips with the initially selected subset of the vision models 106 can be used to build an index of the video. For example, the index may include object detection information to identify clips within the video that have frames relevant to particular objects. Thus, if a query asks for a truck within the video, the index can be used to identify clips that feature a truck. More detailed information can then be extracted from these relevant clips, for example using another model to extract text from the image to identify the owner of the truck or its license plate number. A relatively heavyweight model, with many parameters, may be used selectively on the video clips that align with the query 112. This targeted, incremental approach optimizes the use of computational resources while maintaining high analytical accuracy.

The user query 112 can be converted into a prompt for the LLM 108. For example, the following prompt may be used:

You operate as a chatbot that is supported by a retrieval augmented generation system. You will use the following context and your knowledge to answer queries. If you are unable to answer a query, your response is, “Unable to answer query. Please run additional models.”
Context: <context>
Query: <query>

The term <context> is replaced with the metadata that has already been extracted from the video clips and the term <query> is replaced with the user's query 112. When the LLM 108 indicates that it cannot answer the query, one or more additional vision models 106 are selected.

A planner may embed the metadata outputs of the vision models 106, for example generated during a pre-processing phase, and these embedded outputs may be stored in a text database. The planner may further embed the query 112, for example into a same latent space that is used to embed the preprocessed metadata. The planner may thereby select metadata from the text database by comparing the embedded query to the embedded metadata and selecting the top-N most similar chunks (e.g., measured according to a cosine similarity).

Image information may further be stored in an image database, for example using embedded frame vectors to represent the frames of the video clips. A vision model may embed visual information from each frame into an embedding vector which serves as the frame vector. The frame vectors that are generated during the pre-processing may be stored in the image database. The planner determines a frame vector corresponding to the user's query 112 and may retrieve the top-F matching frames from the image database (e.g., measured according to a cosine similarity).

The planner may thus use retrieved textual information and retrieved frames as context for prompting the LLM 108. The retrieved selected chunks may further be processed to reduce the number of context chunks to a predetermined number, ensuring prompt and interactive query responses. For example, the chunks may include irrelevant clip information. Extracting irrelevant video clip information when additional vision models 106 are called for to answer the query 112 introduces latency without improving results. The planner therefore ensures that at most k context clips are used for further analysis, with k being a user-configurable value. In some cases any number of clips may be selected that meet some similarity threshold. Larger values for k imply a higher limit on the number of contextual clips, while small values for k may include too few clips for detailed extraction, such that the updated index may still not have the context that the LLM 108 needs.

A classifier may be used to group the selected text chunks into two classes: “accept” or “reject.” The classifier may be implemented with, e.g., a k-nearest neighbor (KNN) approach. The embedding of each selected chunk may be concatenated with the query vector to form a feature vector for the classifier, which assigns a label to each. Any vector having the “reject” label may be eliminated from further consideration. If a chunk matches a chunk that is retrieved according to the initially selected vision models 106, then it may be labeled as “accept,” and may be labeled as “reject” otherwise. In some cases, an unlabeled chunk may be labeled as “accept” if three out of five neighbors of the concatenated query-chunk vector have the “accept” label.

An extractor may then run one or more additional vision models 106 on the selected context clips from the planner. Instead of converting the entire video to text using a heavyweight model, the extractor runs the heavyweight model only on the selected context clips deemed to be relevant by the planner. The detailed text data extracted from these context clips is then used to update the text database. The prompt may then be updated with the new contextual text and the query 112 may be re-issued to the LLM 108.

In comparing the vision models 106, lightweight models that have relatively few parameters can execute more quickly than heavyweight models with relatively many parameters. However, a heavyweight model may capture more detailed information than a lightweight model. A heavyweight model may provide a maximum output token limit parameter to control the amount of information that is generated, which in turns controls how quickly the heavyweight model can execute. The appropriate level of detail needed to describe an image or video clip depends on the specific scenario.

For example, an input video clip may include an urban street scene. A lightweight vision model may generate a textual description of the scene that says, “A man riding a bike down the street.” This lightweight model may be used to pre-process the video clips and generate similarly brief text descriptions.

In contrast, a relatively heavyweight model may provide a significantly more detailed description with a length that is set by the maximum output token limit parameter. For example, a description of the same scene with a maximum output token limit of 16 may read, “The image captures a bustling city scene, where life unfolds in its vibrant.” The same model processing the same scene, but with a maximum output token limit of 32, may continue with, “any dynamic form. A white SUV is seen making a left turn at an intersection.” A maximum output token limit of 64 continues with, “, while a man on a red motorcycle is crossing the street, adding a splash of color to the urban landscape. The perspective of the photo suggests it was taken.” The description may be made arbitrarily long, or may terminate when the model generates a termination token.

The heavyweight model in this example may take significantly longer to execute than the lightweight model, thus increasing latency. Thus the heavyweight model may not be executed on every video clip, but may be executed only on selected video clips that are relevant to the query.

During the incremental analysis described above, when a given description from a lightweight model lacks the information needed to answer the query 112, a heavyweight model may be used to generate a more detailed description using a relatively low maximum output token limit. If that more detailed description still lacks the information needed to answer the query 112, the heavyweight model may be used to generate additional output up to a higher maximum output token limit. This process may be repeated with incremental increases in the output length until the query can be answered or until the heavyweight model stops generating new information.

When prompting the heavyweight model, the prompt may include the description from the lightweight model as context. For example, the prompt may read, “Describe additional information in a concise manner. This image captures [lightweight model output]. Moreover, . . . ” The heavyweight model will then use the output of the lightweight model to generate additional information. For example, the heavyweight model processing such a prompt may output, “The image captures a man riding a bike down the street. Moreover, The image also features a white SUV, a person on a motorcycle, and another individual walking. The street has markings for crosswalks and lanes, with.”

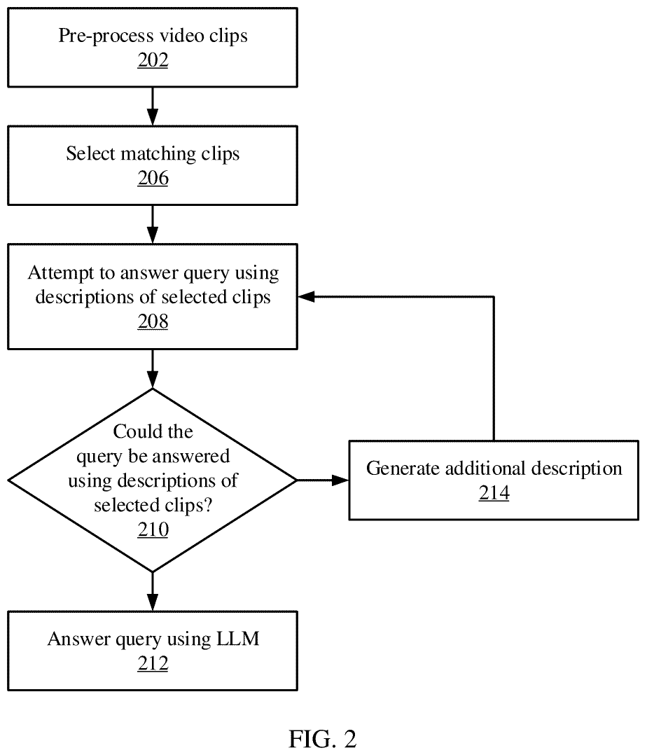

Referring now to FIG. 2, a method of incremental video analysis is shown. Block 202 pre-processes a set of video clips from a given video. In some cases block 202 may pre-process a respective representative frame from each video clip, and in other cases block 202 may pre-process entire video clips. These video clips may show a same scene or may show a changing scene, for example as a video camera 102 moves or pans. The contents of the video clips may furthermore vary, for example as people and objects move through the scene and as the scene itself evolves (e.g., from night to day). The pre-processing of block 202 may perform image analysis using a first vision model. Any exemplary vision language model may be used for the pre-processing 202, with an example being a bootstrapping language-image pre-training (BLIP) model that has an exemplary 247.4 million parameters. The pre-processing of block 202 generates respective textual descriptions for each of the video clips, which may be embedded as vectors and stored in a textual database. The clips themselves may similarly be embedded as vectors that are stored in a video database.

When a query 112 is received, block 206 selects video clips that match the query, for example embedding the query as a vector and matching to entries in the textual database or the video database. These matching clips are likely to include information relevant to the query. Block 208 then uses LLM 108 to attempt to answer the query using the textual descriptions associated with the selected clips. Based on the LLM's response, block 210 determines whether the query could be answered. If not, block 214 generates additional description text from the selected video clips, for example using a heavier-weigh model or using a same model with a larger maximum token output limit. Examples of such heavier-weight models include the InternLM-Xcomposer2 model and the LLAVA model, both of which may have about 7 billion parameters.

This iterative process may continue until either the LLM 108 is able to answer the query using the provided information or until the LLM 108 has generated as much text about the scene as it can, generating a termination token. When the LLM 108 is able to answer the query, block 212 generates the answer and returns it to the user.

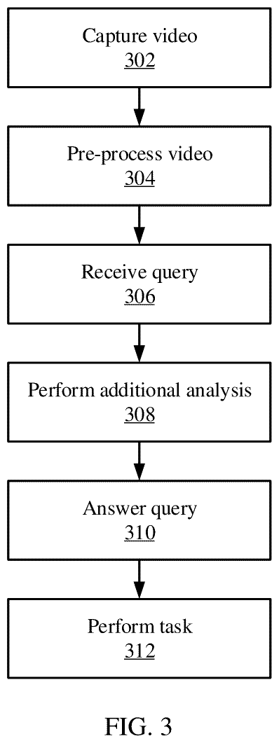

Referring now to FIG. 3, a method for analyzing and responding to video is shown. Block 302 captures video of a scene, for example using a video camera 102. Block 304 pre-processes the video as described above, splitting it into clips and performing an initial analysis using a lightweight vision model. When block 306 receives a query from the user, for example asking for a particular person or vehicle that matches a particular description, block 308 can perform additional analysis.

For example, block 308 may be select clips where the textual description from pre-processing indicates that there is a person or vehicle present. If there is not enough information, for example if the textual description does not describe the person or vehicle with enough particularity to determine whether they match the description, then block 308 may incrementally increase the analysis using a more heavyweight vision model until block 310 can answer the query using an LLM 108.

Block 312 performs a task responsive to the answer. In a security context, for example, where the query asks about potentially suspicious activity within a video, the task may include a security action. Such an action may, for example, call security personnel to a scene, may cause doors to lock or unlock, or may trigger a visual and/or auditory alarm. In some cases the video may be used to enhance medical decision making, as the video analysis may identify points of concern in a video of a medical procedure or may make a diagnosis.

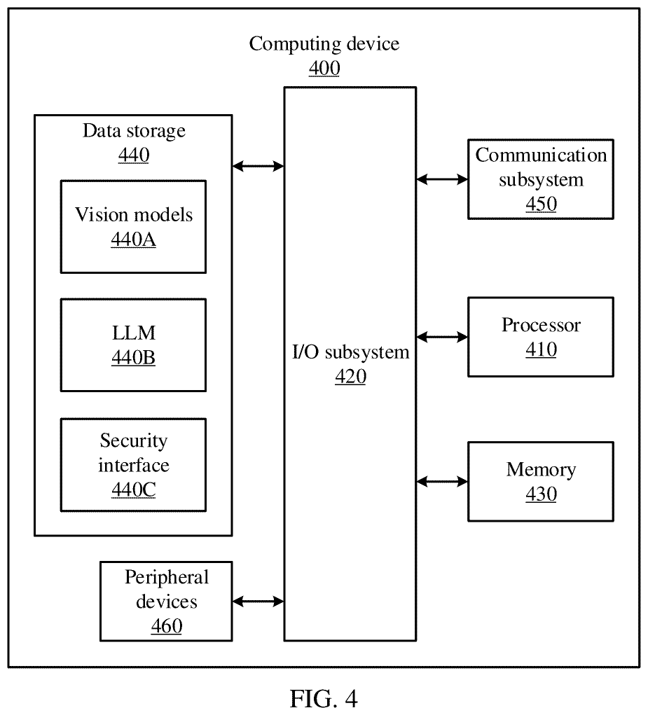

Referring now to FIG. 4, an exemplary computing device 400 is shown, in accordance with an embodiment of the present invention. The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for a vision models, 440B for an LLM, and/or 440C for a security interface that can automatically perform a security action. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

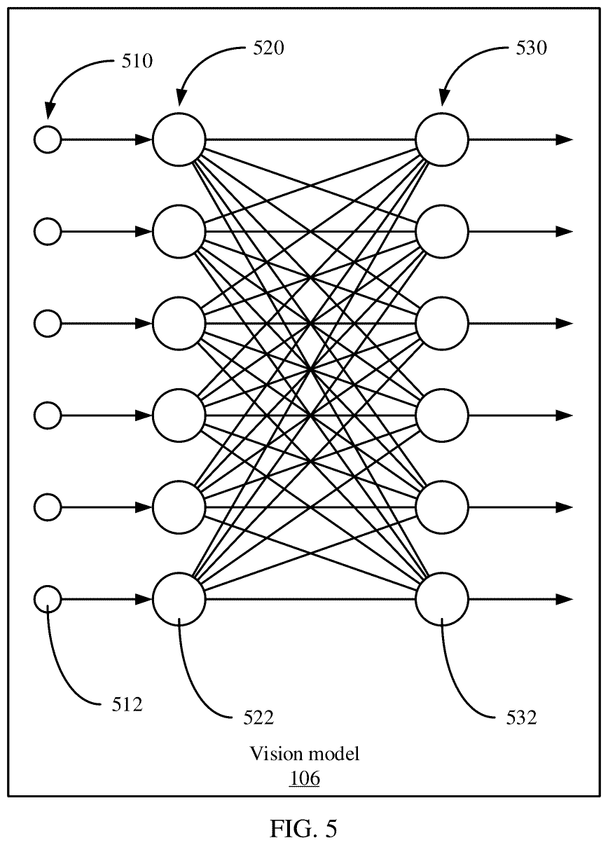

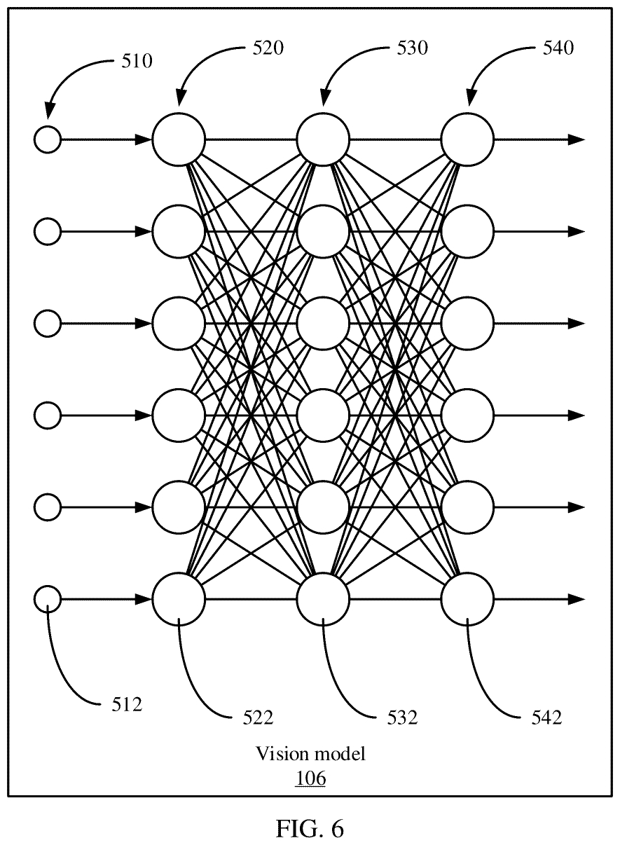

Referring now to FIGS. 5 and 6, exemplary neural network architectures are shown, which may be used to implement parts of the present models, such as the vision models 106. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

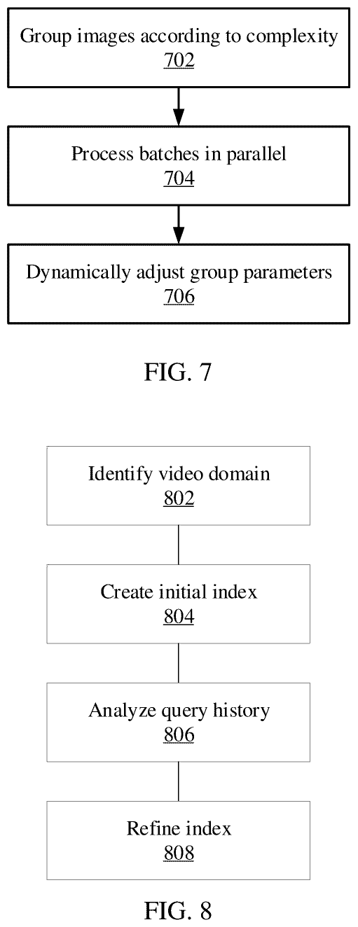

Referring now to FIG. 7, a method for processing video in parallel is shown. To optimize processing time for low-latency video analysis, the clips may be grouped into batches on the basis of their information complexity. The batches may be processed in parallel, with the maximum output token parameter being adjusted dynamically for each group.

Block 702 groups images of the video according to their complexity. This makes it possible to process images with similar complexity together, minimizing processing time for simpler images while allocating more resources for complex images. For example, static or uniform scenes may be grouped separately from dynamic or detailed scenes.

Block 704 then performs batch processing, grouping the images into batches to improve computational efficiency and to reduce the overhead of processing individual images. Batching can reduce the computational overhead associated with processing individual clips and can enhance resource utilization by aligning similar workloads. Block 706 then performs dynamic adjustment of the maximum output token parameter for the groups, tailoring the number of tokens per image based on the complexity of the scene. Dynamically adjusting this parameter based on the complexity of the scene ensures that simpler clips generate concise descriptions without unnecessary computation, while complex clips are allotted more tokens to capture important details.

This parallel processing may be implemented as part of the video analysis described above. In particular, the grouping of images by complexity may be performed as part of the pre-processing 202 or selection 204, and the parallel processing of block 704 may be performed as part of the generation of additional description 214.

Vision language models may process video clips in batches, leveraging the parallel computing power of graphics processing units (GPUs) to enhance efficiency. The completion time for a batch may vary based on the complexity of the video clips and the maximum token limit parameter. Some clips, such as those with intricate details or dynamic scenes, may need more processing time and so may risk truncation of their output to fewer tokens than the maximum, depending on latency needs. Simpler clips may finish earlier. This variability results in inefficiencies in video-to-text analysis, which the present batch selection addresses.

Referring now to FIG. 8, a method for selecting an initial model for pre-processing is shown. The effectiveness of this pre-processing 202 impacts the accuracy and reliability of the entire system, as it may lead to irrelevant clips being selected in block 204. If irrelevant clips are selected, downstream analysis will fail, as it cannot provide accurate results from irrelevant or incomplete clips. Errors introduced during this phase will propagate through the system, producing incorrect answers to queries, degrading system reliability.

Block 802 identifies a domain of the video in question. For example, video surveillance footage may be better served by a model that prioritizes the detection of vehicles and pedestrians (e.g., useful for analyzing traffic flow, accidents, and road usage patterns) and activities (e.g., useful to identify crimes and traffic violations). In contrast, video from a transportation hub may be better served by a model that focuses on determining crowd density to monitor for congestion, tracking luggage movement to identify suspicious behavior and unattended bags, and detecting anomalies like people entering restricted areas.

Block 804 creates an initial index of the video clips using a lightweight video analysis model, based on domain knowledge. Block 806 analyzes query history to capture trends and patterns in the types of information that users seek. The historical data helps to identify gaps in the existing index.

Block 808 then refines the index periodically, based on received query patterns. This may include a change to the model, for example if a domain expert determines metadata categories that are more relevant to the incoming queries. Alternatively an LLM may be used to recommend models that are optimized for the observed patterns. These refinements may be made incrementally, where additional metadata is generated and appended to an existing index to ensure minimal disruption.

An LLM can be used during this indexing to provide descriptive information about the video corpus to recommend suitable video analysis models for the initial indexing. An LLM can also analyze the query history and identify trends, such as repeated queries for specific activities and objects, and can suggest adjustments to the indexing strategy. Based on evolving requirements, LLMs can further propose alternative models that better align with user needs, reducing reliance on manual decision-making.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for video analysis, comprising:
pre-processing a plurality of clips of an input video using a first vision model to generate respective first textual descriptions for the plurality of clips;
selecting a subset of the plurality of clips that are relevant to a query based on the first textual descriptions;
generating additional textual descriptions for the selected subset using a second vision model; and
answering the query using the additional textual descriptions.

2. The method of claim 1, wherein the second vision model has more parameters than the first model.

3. The method of claim 1, wherein generating the additional textual descriptions is repeated until a language model is able to answer the query based on the additional textual descriptions.

4. The method of claim 3, wherein each repetition of generating the additional textual descriptions instructs the second vision model to generate additional tokens that continue a previous output.

5. The method of claim 4, wherein the instruction to generate additional tokens includes increasing a maximum output token limit.

6. The method of claim 3, further comprising prompting the language model to determine whether the language model can answer the query using the first textual descriptions and the additional textual descriptions.

7. The method of claim 1, wherein selecting the subset of the plurality of clips includes embedding the query and the first textual descriptions in a latent space and selecting the subset of the plurality of clips according to a similarity between the embedded query and the embedded first textual descriptions.

8. The method of claim 1, further comprising grouping the plurality of clips according to image complexity.

9. The method of claim 1, wherein pre-processing the plurality of clips includes identifying a domain of the input video and selecting the first vision model according to the domain.

10. The method of claim 9, further comprising updating the domain based on the query.

11. A system for video analysis, comprising:
a hardware processor; and
a memory that stores a computer program which, when executed by the hardware processor, causes the hardware processor to:
pre-process a plurality of clips of an input video using a first vision model to generate respective first textual descriptions for the plurality of clips;
select a subset of the plurality of clips that are relevant to a query based on the first textual descriptions;
generate additional textual descriptions for the selected subset using a second vision model; and
answer the query using the additional textual descriptions.

12. The system of claim 11, wherein the second vision model has more parameters than the first model.

13. The system of claim 11, wherein the generation of the additional textual descriptions is repeated until a language model is able to answer the query based on the additional textual descriptions.

14. The system of claim 13, wherein each repetition of the generation of the additional textual descriptions instructs the second vision model to generate additional tokens that continue a previous output.

15. The system of claim 14, wherein the instruction to generate additional tokens includes an increase to a maximum output token limit.

16. The system of claim 13, wherein the computer program further causes the hardware processor to prompt the language model to determine whether the language model can answer the query using the first textual descriptions and the additional textual descriptions.

17. The system of claim 11, wherein the selection of the subset of the plurality of clips includes an embedding of the query and the first textual descriptions in a latent space and selection of the subset of the plurality of clips according to a similarity between the embedded query and the embedded first textual descriptions.

18. The system of claim 11, wherein the computer program further causes the hardware processor to group the plurality of clips according to image complexity.

19. The system of claim 11, wherein the pre-processing of the plurality of clips includes identification of a domain of the input video and selecting the first vision model according to the domain.

20. The system of claim 19, wherein the computer program further causes the hardware processor to update the domain based on the query.
